(19) United States
(12) Patent Application Publication
(10) Pub. No.: US 2013/0258523 A1
(43) Pub. Date: Oct. 3, 2013

(54) MAGNETIC RECORDING MEDIUM, MAGNETIC RECORDING/REPRODUCING APPARATUS, AND METHOD OF MANUFACTURING MAGNETIC RECORDING MEDIUM

(71) Applicants: Tomoyuki MAEDA, Kawasaki-shi (JP); Hiroyuki HIEDA, Yokohama-shi (JP); Yousuke ISOWAKI, Yokohama-shi (JP); Takuya SHIMADA, Yokohama-shi (JP)

(72) Inventors: Tomoyuki MAEDA, Kawasaki-shi (JP); Hiroyuki HIEDA, Yokohama-shi (JP); Yousuke ISOWAKI, Yokohama-shi (JP); Takuya SHIMADA, Yokohama-shi (JP)

(73) Assignee: KABUSHIKI KAISHA TOSHIBA, Tokyo (JP)

(21) Appl. No.: 13/723,725

(22) Filed: Dec. 21, 2012

(30) Foreign Application Priority Data
Mar. 28, 2012 (JP) 2012-074880

(51) Int. Cl. G11B 5/667

(52) U.S. Cl. CPC G11B 5/667
USPC 360/110; 428/828; 428/828.1; 427/130

(57) ABSTRACT

A magnetic recording medium of an embodiment includes: a substrate; a nonmagnetic base layer disposed on the substrate; a perpendicular magnetic recording layer disposed on the nonmagnetic base layer, having a hard magnetic recording layer, a nonmagnetic intermediate layer, and a soft magnetic recording layer, and divided into mutually separated plural regions; and a protective layer disposed on the perpendicular magnetic recording layer. The hard magnetic recording layer has an easy magnetization axis directed to a stack direction of the hard magnetic recording layer. The nonmagnetic intermediate layer contains one of C, ZnO, a carbide of Si, Ti, Ta or W, and a nitride of Si, Ti, Ta or W.

### CROSS-REFERENCE TO RELATED APPLICATION

This application is based upon and claims the benefit of priority from Japanese Patent Application No. 2012-074880, filed on Mar. 28, 2012; the entire contents of which are incorporated herein by reference.

### FIELD

Embodiments described herein relate generally to a magnetic recording medium, a magnetic recording/reproducing apparatus, and a method of manufacturing a magnetic recording medium.

### BACKGROUND

An increase in storage density of a magnetic storage device (HDD) that records and reproduces information, has been demanded. In order to increase the storage density, a perpendicular magnetic recording method has become to be used as a magnetic recording method of the HDD, in place of an in-plane magnetic recording method. In the perpendicular magnetic recording method, magnetic crystal grains in a magnetic recording layer on a substrate have an easy magnetization axis perpendicular to the substrate.

Here, a patterned medium having a plurality of magnetic dots has been studied. In the patterned medium, microfabrication is performed on a perpendicular magnetic recording layer, to thereby create a plurality of magnetic dots with gaps therebetween. By providing the gaps, the magnetic dots can be magnetically isolated and stabilized.

At this time, in accordance with the realization of high recording density, miniaturization of the magnetic dots becomes necessary. For this reason, in order to maintain a thermal fluctuation resistance of recording magnetization, it becomes necessary to increase a magnetic anisotropic energy density (Ku) of a magnetic material.

Further, in the patterned medium, a switching field distribution (SFD) for each magnetic dot has to be minimized. This is for making a designated magnetic dot reliably reverse magnetization by a recording magnetic field having a set intensity, and preventing magnetization reversal in adjacent magnetic dots.

As the reason why the switching field distribution SFD is caused, there can be cited a distribution of anisotropic magnetic field Hk which is caused as a result of a variation in saturation magnetization Ms and magnetic anisotropic energy density Ku for each magnetic dot. When the magnetic dots are magnetically isolated, the switching field is substantially in proportion to the anisotropic magnetic field Hk, so that a distribution of the anisotropic magnetic field Hk becomes a cause of the switching field distribution SFD. However, generally, it is not easy to reduce the distribution of the anisotropic magnetic field Hk.

### BRIEF DESCRIPTION OF THE DRAWINGS

FIG. 1 is a diagram illustrating a patterned medium according to a first embodiment.

FIG. 2 is a diagram illustrating a patterned medium according to a modified example 1.

FIG. 3 is a diagram illustrating a patterned medium according to a modified example 2.

FIG. 4 is a diagram illustrating a patterned medium according to a modified example 3.

FIG. 5 is a diagram illustrating a magnetic recording/reproducing apparatus according to a second embodiment.

FIG. 6 is a diagram illustrating an evaluation method of a width of coercive force distribution ΔHc.

### DETAILED DESCRIPTION

A magnetic recording medium of an embodiment includes: a substrate; a nonmagnetic base layer disposed on the substrate; a perpendicular magnetic recording layer disposed on the nonmagnetic base layer, having a hard magnetic recording layer, a nonmagnetic intermediate layer, and a soft magnetic recording layer, and divided into mutually separated plural regions; and a protective layer disposed on the perpendicular magnetic recording layer. The hard magnetic recording layer has an easy magnetization axis directed to a stack direction of the hard magnetic recording layer. The nonmagnetic intermediate layer contains one of C, ZnO, a carbide of Si, Ti, Ta or W, and a nitride of Si, Ti, Ta or W.

Hereinafter, embodiments will be described in detail with reference to the drawings.

### First Embodiment

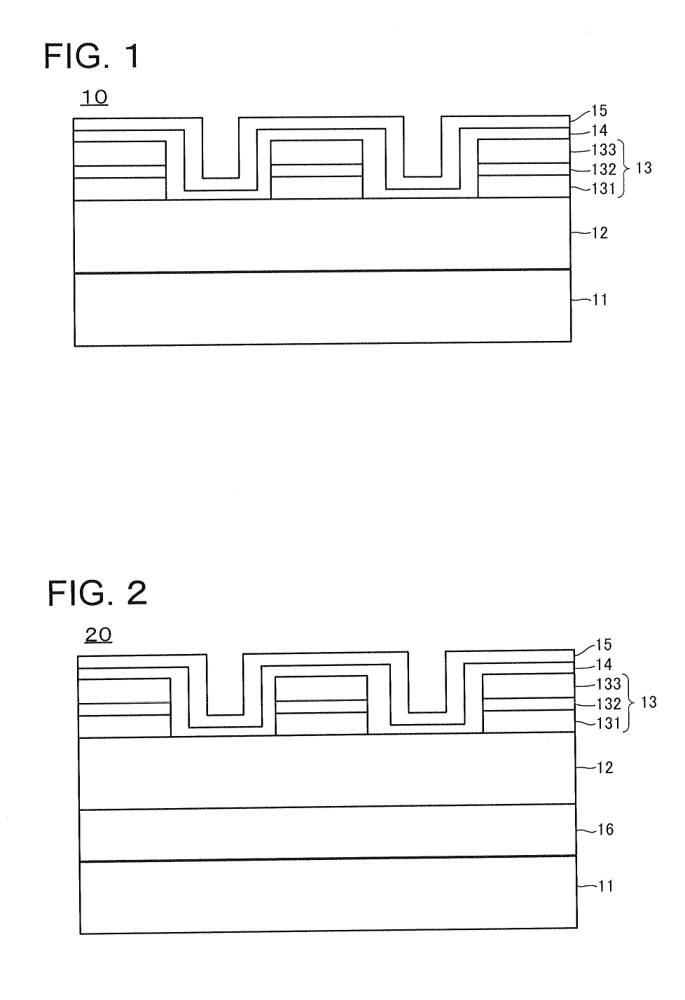

FIG. 1 is a sectional diagram illustrating a patterned medium 10 according to a first embodiment. In the patterned medium 10, a nonmagnetic base layer 12, a perpendicular magnetic recording layer 13, a protective layer 14, and a lubricant layer 15 are sequentially stacked on a substrate 11.

As a material of the substrate 11, it is possible to use nonmagnetic materials such as a glass, an Al-based alloy, an Si single crystal having an oxidized surface, ceramics, and plastic. It is also possible that surfaces of these nonmagnetic materials are plated with an NiP alloy or the like.

In the perpendicular magnetic recording layer 13, a hard magnetic recording layer 131, a nonmagnetic intermediate layer 132, and a soft magnetic recording layer 133 are sequentially stacked.

The perpendicular magnetic recording layer 13 functions as a so-called ECC (Exchange Coupled Composite) medium. By forming the perpendicular magnetic recording layer 13 with the hard magnetic recording layer 131, the nonmagnetic intermediate layer 132, and the soft magnetic recording layer 133 which are sequentially stacked, it is possible to reduce a switching field distribution SFD. In the ECC medium, the hard magnetic recording layer 131 that serves to retain recording magnetization and the soft magnetic recording layer 133 that realizes easy magnetization reversal are coupled by exchange coupling via a thin nonmagnetic intermediate layer 132.

In the ECC medium, a variation in exchange interaction of the soft magnetic recording layer 133 and the hard magnetic recording layer 131 dominantly influences the switching field distribution SFD, compared to a distribution of the anisotropic magnetic field Hk. The variation in the exchange interaction is caused by a variation in film thickness of the nonmagnetic intermediate layer 132, and a control thereof is relatively easy, compared to a control of the distribution of the anisotropic magnetic field Hk. For this reason, by forming the ECC medium, it becomes easy to reduce the switching field distribution SFD. Further, since the switching field is reduced in the ECC medium, the ECC medium is preferable from this viewpoint as well.

The perpendicular magnetic recording layer 13 has a fine-shape array structure. Specifically, the perpendicular magnetic recording layer 13 is divided into mutually separated plural regions (magnetic dots, very little projections having magnetism). To create the fine-shape array structure, it is possible to use the following procedures (1) and (2), for example.

### (1) Formation of Mask on Surface of Perpendicular Magnetic Recording Layer 13 (Medium)

A mask material such as SOG (Spin On Glass) is coated on the perpendicular magnetic recording layer 13. Thereafter, by using a stamper having a dot pattern, a concave and convex pattern is formed on the mask material (SOG mask) by nanoimprinting (transfer).

### (2) Etching of Perpendicular Magnetic Recording Layer 13

The perpendicular magnetic recording layer 13 is etched by Ar ion milling. After that, the SOG mask is removed from the perpendicular magnetic recording layer 13 by reactive ion milling (RIE) using CF₄ gas.

Note that it is also possible to form a mask on the perpendicular magnetic recording layer 13 by using a self-assembling material, through the following procedures (a) to (c).

### (a) Formation of Self-Assembled Layer on Perpendicular Magnetic Recording Layer 13 (Medium)

A self-assembled layer is formed on the perpendicular magnetic recording layer 13. Specifically, on the perpendicular magnetic recording layer 13, a layer of self-assembling material (PS (polystyrene)-PMMA (polymethyl methacrylate) diblock polymer, for example) is formed, and is self-assembled through annealing by heating or the like. Specifically, the diblock polymer (self-assembled layer) is separated into two phases (a phase of PS and a phase of PMMA).

### (b) Etching of Self-Assembled Layer

The self-assembled layer is etched. The reactive ion milling (RIE) using O₂ gas, for example, is performed on the diblock polymer. PS and PMMA have a different resistance to etching by the milling, so that the diblock polymer is etched by corresponding to a phase structure of the diblock polymer (formation of self-assembled pattern).

Note that the self-assembled pattern created as above can be used as the stamper in the above-described nanoimprinting. (c) Coating and Etching of Mask Material on Self-Assembled Layer

A mask material such as SOG (Spin On Glass) is coated on the self-assembled layer (self-assembled pattern), and etching is performed. The reactive ion milling (RIE) using O₂ gas, for example, is performed on the mask material. As a result of this, the mask material has a dot pattern corresponding to the self-assembled pattern.

After that, as described in the aforementioned procedure (2), the perpendicular magnetic recording layer 13 is etched, which enables to create a fine-shape array structure.

The hard magnetic recording layer 131 is formed of hard magnetic crystal grains having an easy magnetization axis directed to a stack direction of the hard magnetic recording layer 131 (direction perpendicular to the substrate 11). A material of the hard magnetic crystal grains preferably has proper coercive force Hc and nucleation magnetic field Hn, and high magnetic anisotropic energy density Ku. The proper coercive force He and nucleation magnetic field Hn are required to suppress the generation of reversed domain against an external magnetic field, a stray magnetic field or the like. The high magnetic anisotropic energy density Ku is required to obtain a sufficient thermal fluctuation resistance. It can be expressed that the easy magnetization axis is directed to the stack direction of the hard magnetic recording layer 131.

As a material of the hard magnetic crystal, one having an L1₀ structure, and having a magnetic metal element and a noble metal element as its main constituent, is preferably used. The magnetic metal is at least one kind selected from Fe and Co, and the noble metal element is at least one kind selected from the group consisting of Pt and Pd. Concretely, an Fe—Pt alloy, a Co—Pt alloy, or an Fe—Pd alloy in which an atomicity ratio between the magnetic element and the noble metal element is within a range of 4:6 to 6:4, can be used. When these materials have the L1₀ structure (when they are ordered alloys), they achieve a very large magnetic anisotropic energy density Ku of 10⁷ erg/cc or more in a c-axis direction, and are excellent in the thermal fluctuation resistance.

For the purpose of improving magnetic properties or electromagnetic conversion characteristics, it is also possible to add proper amounts of elements such as Cu, Zn, Zr, Cr, Ru, and Ir to the hard magnetic recording layer 131.

Whether the crystal grains forming the hard magnetic recording layer 131 have the L1, structure can be confirmed by a general X-ray diffraction apparatus. It can be the that the L1, structure exists if peaks (ordered lattice reflections) representing planes ((001), (003) planes and the like) which are not observed in a disordered face-centered cubic lattice (FCC) can be observed at diffraction angles matching the respective interplanar spacings.

As an index for evaluating whether the hard magnetic crystal grains have a structure close to a perfect L1, structure, a degree of order S is generally used. When “degree of order S=1” is satisfied, it indicates the perfect L1₀ structure, and when “degree of order S=0” is satisfied, it indicates a perfect random structure. In a case of the aforementioned alloys, generally, the higher the degree of order S, the higher the magnetic anisotropic energy density Ku, which is preferable. For the evaluation of the degree of order S, integrated intensities of the peaks of the respective (001), (002) planes obtained by X-ray diffraction measurement are used, and the evaluation can be conducted through the following expression.

S=0.72·(I₀₀₁/I₀₀₂)^{1/2}

Here, I₀₀₁ and I₀₀₂ are the integrated intensities of diffraction peaks of the (001), (002) planes, respectively. In the patterned medium, when the degree of order S exceeds 0.6, it can be the that the L1₀ structure exists.

Further, whether the material of the hard magnetic crystal is oriented in the (001) plane (oriented in the c-axis), can also be confirmed by using a general X-ray diffraction apparatus.

The above-described hard magnetic material tends to form a disordered phase being a metastable phase, when it is deposited at room temperature. Accordingly, there is a need to cause ordered alloying by heating the substrate 11 during the deposition or after the deposition.

However, if the substrate 11 is heated during the deposition of the hard magnetic recording layer 131, fine roughness is formed on a surface of the hard magnetic recording layer 131, resulting in that smoothness is deteriorated, which was proved by an experiment. For this reason, the pattern transfer in the pattern processing described above becomes difficult. Concretely, when a temperature of the substrate 11 during the deposition of the hard magnetic recording layer 131 exceeds 200° C., an average roughness of the surface of the hard magnetic recording layer 131 significantly increases, which is unfavorable.

Meanwhile, if the substrate 11 is heated after the deposition of the hard magnetic recording layer 131, the roughness is not generated on the surface of the hard magnetic recording layer 131 almost at all, so that the pattern transfer can be performed. However, if the substrate 11 is heated before the pattern processing to cause the ordered alloying of the hard magnetic recording layer 131, ions are irradiated also to a sidewall portion of the magnetic dot when performing milling in the pattern processing. As a result of this, a phase of the sidewall portion is transformed into a disordered phase, and the thermal fluctuation resistance is lowered, which was proved by an experiment.

On the contrary, if the substrate 11 is heated after the pattern processing, the roughness is not generated on the surface of the hard magnetic recording layer 131 almost at all, so that the pattern transfer can be performed. Further, since the ordered alloying of the hard magnetic recording layer 131 including the aforementioned sidewall portion to which the ions are irradiated, is caused, the thermal fluctuation resistance is difficult to be deteriorated.

A heating temperature of the substrate 11 after the pattern processing is preferably within a range of 400° C. to 600° C., and is more preferably within a range of 450° C. to 550° C. When the temperature of the substrate 11 is less than 400° C., the degree of order S is lowered. When the temperature of the substrate 11 exceeds 600° C., deterioration such as a crack occurs on the substrate 11.

Further, when the above-described hard magnetic material is deposited by a sputtering method, it is preferable to set a pressure of rare gas of Ar or the like (sputtering gas) to fall within a range of 4 Pa to 12 Pa, since the degree of order S is improved. It is more preferable that the pressure of sputtering gas is set to fall within a range of 5 Pa to 10 Pa.

The nonmagnetic intermediate layer 132 formed between the hard magnetic recording layer 131 and the soft magnetic recording layer 133 has a function of properly weakening an exchange coupling force between the both layers to form the ECC medium, and also has a function of suppressing alloying of a hard magnetic crystal and a soft magnetic crystal at a time of the aforementioned heating process.

As the nonmagnetic intermediate layer 132, a simple substance of C, a carbide material such as TaC, TiC, SiC or WC, or a nitride material such as TaN, TiN, SiN, or WN, can be preferably used. These materials have a high melting point and are very thermostable, and thus provide a high effect of suppressing the alloying of the hard magnetic crystal and the soft magnetic crystal at the time of the heating process.

When the carbide is used, a C composition of 50 to 100 atom % is preferable, which was proved by an experiment. Further, when the nitride is used, an N composition within a range of 30 to 60 atom % is preferable, which was proved by an experiment. The C and N compositions in the nonmagnetic intermediate layer 132 can be analyzed by using, for example, an X-ray photoelectron spectroscopy (XPS).

It is possible to preferably use ZnO as the nonmagnetic intermediate layer 132. ZnO is thermostable. In addition to that, a milling rate with respect to ZnO at a time of processing the perpendicular magnetic recording layer 13 is greater than that with respect to general compounds such as an oxide, a nitride, and a carbide, so that it is easy to perform pattern processing.

A film thickness of the nonmagnetic intermediate layer 132 is preferably within a range of 0.2 nm to 2 nm, and is more preferably within a range of 0.5 nm to 1 nm. When the film thickness is less than 0.2 nm, the aforementioned diffusion suppression effect is difficult to be exhibited, and when it exceeds 2 nm, the exchange interaction that acts between the hard magnetic recording layer and the soft magnetic recording layer is significantly reduced, which is unfavorable.

When the nonmagnetic intermediate layer 132 is deposited by a sputtering method, the pressure of rare gas of Ar or the like (sputtering gas) is preferably low, since it is easy to form a dense film, and the aforementioned diffusion suppression effect is increased. Concretely, a range of the pressure of sputtering gas is preferably set to 0.1 Pa to 2 Pa.

As a sputtering target material when depositing ZnO as the nonmagnetic intermediate layer 132 using a sputtering method, it is preferable to use one obtained by adding a small amount of Al₂O₃ to ZnO. A conductivity of the target material is increased, and a DC sputtering method can be used. In that case, Al₂O of about several mol % may also be contained in the nonmagnetic intermediate layer 132.

The soft magnetic recording layer 133 has a function of assisting the magnetization reversal of the hard magnetic recording layer 131 and reducing the switching field. Therefore, it is preferable that the anisotropic magnetic field Hk of the soft magnetic recording layer 133 is considerably smaller than the anisotropic magnetic field Hk of the hard magnetic recording layer 131.

As a composing material of the soft magnetic recording layer 133, there can be cited Co, Fe, a Co—Pt alloy, and an Fe—Pt alloy. Among the above, the Co—Pt alloy and the Fe—Pt alloy are more preferable. Since the Co—Pt alloy and the Fe—Pt alloy contain Pt, they have a high oxidation resistance, and thus can suppress deterioration of properties due to the oxidation at the time of performing RIE processing using O₂. It is preferable that these alloys are not the aforementioned ordered alloys but have an FCC structure, and in which a Pt composition is within a range of 40 to 70 atom %.

These alloys have substantially the same composition as that of the composing material of the aforementioned hard magnetic recording layer 131, so that it is easy to cause ordered alloying through the heating of the substrate 11 after the pattern processing.

The present inventors conducted earnest studies regarding this point, and as a result of this, they found out that when the soft magnetic recording layer 133 is deposited under a low gas pressure in a case of the deposition using a sputtering method, the ordered alloying through the heating can be suppressed. Concretely, it is preferable to perform the deposition by a sputtering method under the condition where the gas pressure is within a range of 0.1 to 2 Pa, which was proved by an experiment.

For the purpose of improving the oxidation resistance of the soft magnetic recording layer 133, it is possible to add an element having a relatively high affinity with oxygen, to the soft magnetic recording layer 133. Concretely, Si, Ti, Al, Mg, and Cr are preferably used. By adding these elements, when the aforementioned RIE processing using oxygen is conducted, the additive elements are preferentially oxidized, which enables to suppress the oxidation of the magnetic element.

An addition amount of these elements is preferably within a range of 1 to 10 atom %, and is more preferably within a range of 3 to 5 atom %. If the addition amount is less than 1 atom %, the oxidation suppression effect does not remarkably appear. If the addition amount exceeds 10 atom %, the magnetic properties of the soft magnetic recording layer 133 deteriorate. A composition of these elements in the soft magnetic recording layer 133 can be analyzed by using, for example, an X-ray photoelectron spectroscopy (XPS).

Although a required value of the system determines the total thickness of the perpendicular magnetic recording layer 13, generally, the total thickness is preferably less than 20 nm, and is more preferably less than 5 nm. If the total thickness of the perpendicular magnetic recording layer 13 exceeds 20 nm, it becomes difficult to perform dot pattern processing. If the total thickness of the perpendicular magnetic recording layer 13 is less than 0.5 nm, a signal strength at a time of reproduction is significantly reduced.

The nonmagnetic base layer 12 has a function of controlling a crystal orientation of the perpendicular magnetic recording layer 13. As a concrete material, MgO or TiN oriented in the (100) plane can be preferably used. A film thickness of the nonmagnetic base layer 12 is preferably within a range of 1 nm to 20 nm, and is more preferably within a range of 3 nm to 10 nm. If the film thickness is less than 1 nm, the aforementioned orientation dispersion reduction effect is difficult to be remarkably appeared. If the film thickness exceeds 20 nm, a magnetic space between a later-described soft magnetic base layer 18 and the perpendicular magnetic recording layer 13 becomes too large to lower recording characteristics (writability).

### Modified Example 1

FIG. 2 is a sectional diagram illustrating a patterned medium 20 according to a modified example 1. In the patterned medium 20, a second nonmagnetic base layer 16, a nonmagnetic base layer 12, a perpendicular magnetic recording layer 13, a protective layer 14, and a lubricant layer 15 are sequentially stacked on a substrate 11. The perpendicular magnetic recording layer 13 is formed by sequentially stacking a hard magnetic recording layer 131, a nonmagnetic intermediate layer 132, and a soft magnetic recording layer 133, and has a patterned fine-shape array structure.

For the purpose of improving a crystal orientation of the nonmagnetic base layer 12, it is possible to provide the second nonmagnetic base layer 16 between the nonmagnetic base layer 12 and the substrate 11. Concretely, it is possible to use Cr or a Cr alloy oriented in the (100) plane. As the Cr alloy, a Cr—Ru alloy or a Cr—Ti alloy can be preferably used.

A film thickness of the second nonmagnetic base layer 16 is preferably within a range of 1 nm to 20 nm, and is more preferably within a range of 5 nm to 10 nm. If the film thickness is less than 1 nm, the aforementioned orientation dispersion reduction effect is difficult to be remarkably appeared. If the film thickness exceeds 20 nm, a magnetic space between a later-described soft magnetic base layer 18 and the perpendicular magnetic recording layer 13 becomes too large to lower recording characteristics (writability).

### Modified Example 2

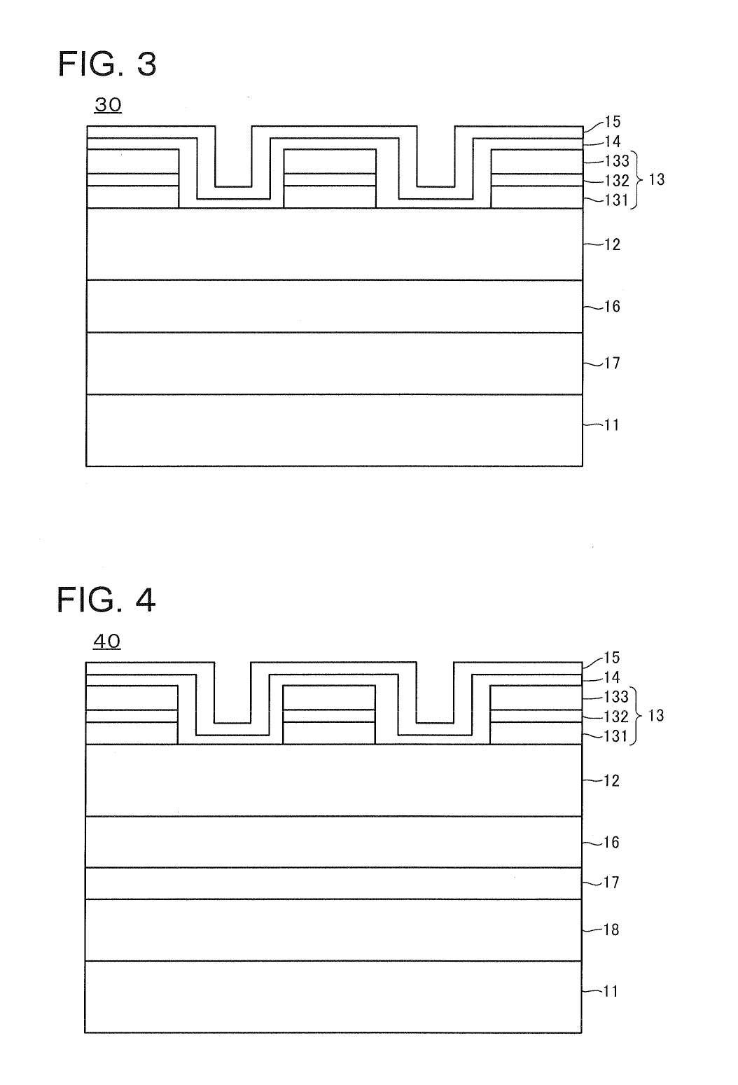

FIG. 3 is a sectional diagram illustrating a patterned medium 30 according to a modified example 2. In the patterned medium 30, an amorphous seed layer 17, a second nonmagnetic base layer 16, a nonmagnetic base layer 12, a perpendicular magnetic recording layer 13, a protective layer 14, and a lubricant layer 15 are sequentially stacked on a substrate 11. The perpendicular magnetic recording layer 13 is formed by sequentially stacking a hard magnetic recording layer 131, a nonmagnetic intermediate layer 132, and a soft magnetic recording layer 133, and has a patterned fine-shape array structure.

It is preferable to dispose the amorphous seed layer 17 made of an amorphous alloy containing Ni between the second nonmagnetic base layer 16 and the substrate 11, since the orientation dispersion in the (100) plane of the nonmagnetic base layer 12 is improved.

The amorphous mentioned here does not necessarily mean a complete amorphous such as glass, and may also mean a film in which fine crystals having a grain size of 2 nm or less are locally oriented at random.

As such an alloy containing Ni, an alloy system such as, for example, an Ni—Nb alloy, an Ni—Ta alloy, an Ni—Zr alloy, an Ni—W alloy, an Ni—Mo alloy, or an Ni—V alloy can be preferably used.

When an Ni content in each of these alloys is within a range of 20 to 70 atom %, the alloy easily becomes amorphous, which is preferable. Further, there is a case where it is preferable to make a surface of the seed layer to be exposed to an atmosphere containing oxygen.

A film thickness of the amorphous seed layer 17 is preferably within a range of 1 nm to 20 nm, and is more preferably within a range of 5 nm to 10 nm. If the film thickness is less than 1 nm, the aforementioned orientation dispersion reduction effect is difficult to be remarkably appeared. If the film thickness exceeds 20 nm, a magnetic space between a later-described soft magnetic base layer 18 and the perpendicular magnetic recording layer 13 becomes too large to lower recording characteristics (writability).

### Modified Example 3

FIG. 4 is a sectional diagram illustrating a patterned medium 40 according to a modified example 3. In the patterned medium 40, a soft magnetic base layer 18, an amorphous seed layer 17, a second nonmagnetic base layer 16, a nonmagnetic base layer 12, a perpendicular magnetic recording layer 13, a protective layer 14, and a lubricant layer 15 are sequentially stacked on a substrate 11. The perpendicular magnetic recording layer 13 is formed by sequentially stacking a hard magnetic recording layer 131, a nonmagnetic intermediate layer 132, and a soft magnetic recording layer 133, and has a patterned fine-shape array structure.

By providing a high-permeability soft magnetic base layer 18 between the nonmagnetic base layer 12 and the substrate 11, a so-called perpendicular double-layered medium is formed. In this perpendicular double-layered medium, the soft magnetic base layer 18 performs a part of a function of a magnetic head. Specifically, the soft magnetic base layer 18 horizontally passes a recording magnetic field from the magnetic head for magnetizing the perpendicular magnetic recording layer 13 such as, for example, a single-pole magnetic head, and returns the recording magnetic field to the magnetic head side. The soft magnetic base layer 18 can play a role of improving a recording/reproduction efficiency by applying steep and sufficient perpendicular magnetic field to the magnetic field recording layer.

As a composing material of the soft magnetic base layer 18, there can be cited, for example, CoZrNb, CoB, CoTaZr, FeSiAl, FeTaC, CoTaC, NiFe, Fe, FeCoB, FeCoN, FeTaN, CoIr, and the like.

The soft magnetic base layer 18 may also be a multilayered film having two or more layers. In such a case, materials, compositions, and film thicknesses of the respective layers may be different. Further, the soft magnetic base layer 18 may also have a three-layered structure in which these two layers are stacked with a thin Ru layer therebetween. A film thickness of the soft magnetic base layer 18 is appropriately adjusted based on a balance between Over Write (OW) characteristics and Signal Noise Ratio (SNR).

The protective layer 14 can be provided on the perpendicular magnetic recording layer 13. As the protective layer 14, for example, C, diamond-like carbon (DLC), SiNx, SiOx, or CNx can be cited.

As a lubricant that forms the lubricant layer 15, perfluoropolyether (PFPE) can be used, for example.

As a deposition method of the respective layers, a vacuum deposition method, a sputtering method, a chemical vapor deposition method, or a laser ablation method can be used. As the sputtering method, it is possible to use a single-target sputtering method using a composite target, and a multitarget co-sputtering method using targets of respective substances.

### Second Embodiment

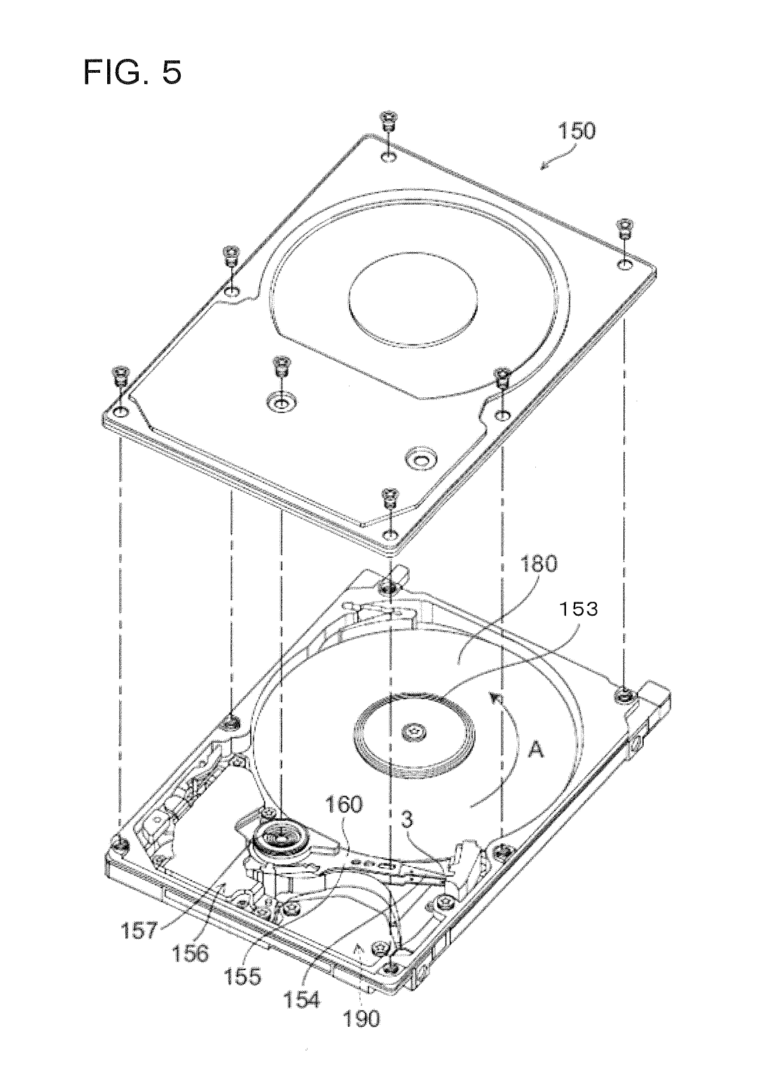

FIG. 5 is a diagram illustrating a magnetic recording/reproducing apparatus 150 according to a second embodiment.

The magnetic recording/reproducing apparatus 150 is an apparatus in a system of using a rotary actuator. A recording medium disk 180 is mounted on a spindle motor 153, and rotated in a direction of arrow mark A by a motor (not illustrated) which responds to a control signal from a driving device control part (not illustrated). It is also possible to design such that the magnetic recording/reproducing apparatus 150 according to the present embodiment includes a plurality of recording medium disks 180.

When the recording medium disk 180 is rotated, a pressing pressure provided by a suspension 154 and a pressure generated at an air bearing surface (which is also referred to as ABS) of a head slider are balanced. As a result of this, the air bearing surface of the head slider is held with a predetermined floating amount from a surface of the recording medium disk 180.

The suspension 154 is connected to one end of an actuator arm 155 having a bobbin part holding a driving coil (not illustrated) and the like. A voice coil motor 156 being one kind of a linear motor is provided at the other end of the actuator arm 155. The voice coil motor 156 can be formed of the driving coil (not illustrated) wound up into the bobbin part of the actuator arm 155, and a magnetic circuit formed of a permanent magnet and a counter yoke disposed to face each other so as to sandwich the coil.

The actuator arm 155 is held by ball bearings (not illustrated) provided at two places above and below a bearing part 157, and a rotational sliding thereof can be freely made by the voice coil motor 156. As a result of this, the magnetic recording head can be moved to an arbitrary position of the recording medium disk 180.

### EXAMPLES

Hereinafter, examples will be concretely described.

### Example 1

A 2.5-inch hard disk-shaped nonmagnetic glass substrate 11 (TS-10SX, manufactured by OHARA) was introduced into a vacuum chamber of c-3010 sputtering apparatus manufactured by ANELVA.

After the vacuum chamber of the sputtering apparatus was evacuated to 1×10⁻⁵ Pa or less, a 20-nm thick Co-5% Zr-5% Nb alloy as the soft magnetic base layer 18, and 5-nm thick Ni-40% Ta as the amorphous seed layer 17, were sequentially deposited. Thereafter, Ar-1% O₂ gas was introduced so that a pressure in the chamber became 5×10⁻² Pa, and a surface of the amorphous seed layer 17 was exposed in the Ar/O2 atmosphere for 5 seconds. After that, 5-nm thick Cr as the second nonmagnetic base layer 16, 5-nm thick MgO as the nonmagnetic base layer 12, 5-nm thick Fe-50% Pt as the soft magnetic recording layer 131, 1-nm thick C as the nonmagnetic intermediate layer 132, and 1-nm thick Co-50% Pt as the soft magnetic recording layer 133, were sequentially deposited.

After the deposition, the perpendicular magnetic recording layer 13 was patterned in dot shape in the following manner. The substrate 11 was taken out from the sputtering apparatus, the substrate was then coated with a solution prepared by dissolving a PS (polystyrene)-PMMA (polymethyl methacrylate) diblock polymer in an organic solvent, using a spin coat method, and the resultant was subjected to heat treatment at 200° C. (formation of self-assembled layer). After that, phase-separated PMMA was removed by RIE using O₂ gas (formation of self-assembled pattern). Subsequently, SOG was formed by spin coating, and RIE using O₂ gas was performed again, thereby forming a dot-shaped mask made of SOG.

Thereafter, the perpendicular magnetic recording layer 13 was etched by Ar ion milling, and the SOG mask was removed by RIE using CF₄ gas, thereby forming a 17-nm pitch bit pattern array.

After the mask was removed, the substrate 11 was introduced into the sputtering apparatus again, and the substrate 11 was heated to 500° C. by using an infrared lamp heater. A period of time of heating was 30 seconds, and the temperature was kept for 1 second. Thereafter, 5-nm thick C was deposited as the protective layer 14, and perfluoropolyether was coated as the lubricant layer 15 by a dip method, thereby forming a patterned medium.

The pressure of Ar gas was 0.7 Pa when each of the soft magnetic base layer 18, the amorphous seed layer 17, the second nonmagnetic base layer 16, the nonmagnetic intermediate layer 132, the soft magnetic recording layer 133, and the protective layer 14 was deposited, the pressure of Ar gas when the nonmagnetic base layer 12 was deposited was 2 Pa, and the pressure of Ar gas when depositing FePt was 8 Pa.

The sputtering targets used for forming the soft magnetic base layer 18, the amorphous seed layer 17, the second nonmagnetic base layer 16, the nonmagnetic base layer 12, the hard magnetic recording layer 131, the nonmagnetic intermediate layer 132, the soft magnetic recording layer 133, and the protective layer 14 were Co-5% Zr-5% Nb, Ni-40% Ta, Cr, MgO, Fe-50% Pt, C, Co-50% Pt, and C, each having a diameter of 164 mm.

MgO was deposited by using an RF sputtering method, and the others were deposited by using a DC sputtering method. An input power to each target was 100 W. A distance between the target and the substrate 11 was 50 mm.

In addition, a medium using Co-50% Pt, instead of Fe-50% Pt, was also formed.

### Comparative Example 1

As a comparative example, a patterned medium using no nonmagnetic intermediate layer 132 and soft magnetic recording layer 133, was formed in the following manner. The patterned medium was formed in a similar manner to the example 1, except that the nonmagnetic intermediate layer 132 and the soft magnetic recording layer 133 were not deposited.

### Comparative Example 2

As a comparative example, a patterned medium using no nonmagnetic intermediate layer 132 was formed in the following manner. The patterned medium was formed in a similar manner to the example 1, except that the nonmagnetic intermediate layer 132 was not deposited.

### Comparative Example 3

As a comparative example, a patterned medium using Pt, Pd, Ru, Cu, Ti, Re, Ir or Cr as the nonmagnetic intermediate layer 132, was formed in the following manner. The patterned medium was formed in a similar manner to the example 1, except that Pt, Pd, Ru, Cu, Ti, Re, Ir or Cr, instead of C, was deposited as the nonmagnetic intermediate layer 132.

### Comparative Example 4

As a comparative example, a patterned medium in which the substrate 11 was heated before depositing the hard magnetic recording layer 131, was formed in the following manner.

Layers up to the nonmagnetic intermediate layer 132 were sequentially deposited in a similar manner to the example 1, and thereafter, the substrate 11 was heated to 500° C. using an infrared lamp heater. A period of time of heating was 30 seconds, and the temperature was kept for 1 second. After that, the nonmagnetic intermediate layer 132 and the soft magnetic recording layer 133 were deposited, and the pattern processing was conducted in a similar manner to the example 1. Further, the protective layer 14 was deposited, and the lubricant was coated in a similar manner to the example 1, thereby forming the patterned medium.

### Comparative Example 5

As a comparative example, a patterned medium in which the substrate 11 was heated before performing the pattern processing, was formed in the following manner. Layers up to the soft magnetic recording layer 133 were sequentially deposited in a similar manner to the example 1, and thereafter, the substrate 11 was heated to 500° C. using an infrared lamp heater. A period of time of heating was 30 seconds, and the temperature was kept for 1 second. After that, the pattern processing was conducted in a similar manner to the example 1, and thereafter, the protective layer 14 was deposited, and the lubricant was coated in a similar manner to the example 1, thereby forming the patterned medium.

A crystal structure and a crystal plane orientation of each of the obtained patterned media were evaluated by X-ray diffraction. By using an X-ray diffraction apparatus (X'pert-MRD) manufactured by Philips, a Cu-Kα line was generated under conditions where an acceleration voltage was 45 kV and a filament current was 40 mA. The crystal structure and the crystal plane orientation were evaluated by a θ-2θ method.

A hysteresis loop in a direction perpendicular to the film of the perpendicular magnetic recording layer 13 of each patterned medium was evaluated. The hysteresis loop was evaluated by a polar Kerr effect evaluating apparatus manufactured by NEOARK (BH-M800UV-HD-10) by using a laser light source having a wavelength of 408 nm under conditions where a maximum applied magnetic field was 20 kOe and a magnetic field sweep rate was 133 Oe/sec.

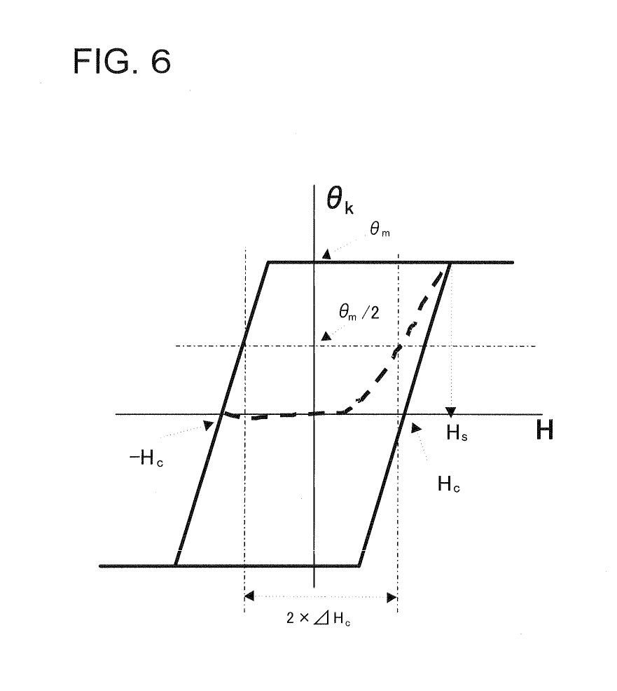

The switching field distribution SFD of each patterned medium was evaluated by a ΔHc/Hc method using a polar Kerr effect measuring apparatus. FIG. 6 represents a width of coercive force distribution ΔHc and an evaluation method thereof. Specifically, after the hysteresis loop (thick solid line) is obtained in the same manner as above, the applied magnetic field is turned to a saturation magnetic field Hs from a point of −Hc on the hysteresis loop, thereby obtaining a minor loop (thick dotted line).

A difference between a magnetic field that is θs/2 on the minor loop and a magnetic field on the second quadrant of the hysteresis loop is regarded as 2ΔHc, and ΔHc/Hc is obtained by normalization by the coercive force Hc. The switching field distribution SFD was determined by the following expression.

SFD=ΔHc/(1.38·Hc)

Further, by using the above apparatus, a thermal fluctuation resistance index β of each patterned medium was evaluated in the following manner. Note that the larger the value of the thermal fluctuation resistance index β, the higher the thermal fluctuation resistance.

The thermal fluctuation resistance index can be obtained from a magnetic field application time (t) dependence of a remnant coercive force Hcr (Hcr(t)), by using the following expression.

Hcr(t)=H₀(1−(1n(f₀·t)/thermal fluctuation resistance index β)^{0.5})

Here, H₀ is a coercive force at a time zero, f₀ is a frequency factor (10⁹ seconds), and the thermal fluctuation resistance index β is a thermal fluctuation resistance index (thermal fluctuation resistance index β=Ku·V/(kB·T)). Ku is a magnetic anisotropic energy density, V is an activation volume, kB is a Boltzmann constant, and T is an absolute temperature. The thermal fluctuation resistance index β and the coercive force H₀ can be determined by fitting with respect to various periods of time (t).

In order to use a result of normal Kerr measurement in this determination, measurement was conducted by changing a sweep rate t_{swp}, and the obtained coercive force Hc(t_{swp}) was converted into the remnant coercive force Hcr(t). This conversion was conducted by solving an expression described in a document (M. P. Sharrock: IEEE Trans. Magn. 35 p. 4414 (1999)), in a self-consistent manner.

A microstructure of each layer of each perpendicular magnetic recording medium was evaluated by using a transmission electron microscope (TEM) with an acceleration voltage of 400 kV. A composition of each layer of each perpendicular magnetic recording medium was evaluated by using an energy dispersive X-ray spectroscopy (TEM-EDX) and an X-ray photoelectron spectroscopy (XPS). A dot shape of each patterned medium was evaluated by using a scanning electron microscope (SEM).

As a result of the evaluation of X-ray diffraction (XRD), it was found out that the crystal grains of the hard magnetic recording layer 131 of each medium were oriented in the (001) plane. It was found out that in each medium, the nonmagnetic base layer 12 and the second nonmagnetic base layer 16 were oriented in the (100) plane. In each medium, the amorphous seed layer 17 was found out to be amorphous. The crystal grains of the hard magnetic recording layer 131 of the patterned medium in each of the examples 1, the comparative example 1, and the comparative example 2, were found out to have the L1₀ structure. It was found out that the soft magnetic recording layer 133 of the patterned medium in each of the examples 1 had the fcc structure.

As a result of the cross-section TEM observation, boundaries of the hard magnetic recording layer 131, the nonmagnetic intermediate layer 132, and the soft magnetic recording layer 133 in the perpendicular magnetic recording layer 13 of the patterned medium in each of the examples 1, the comparative example 4, and the comparative example 5, were clearly observed, and thus the perpendicular magnetic recording layer 13 was found out to have a three-layered structure. Meanwhile, in the patterned medium in the comparative example 2, a boundary of the hard magnetic recording layer 131 and the soft magnetic recording layer 133 was unclear. Further, a boundary was similarly unclear also in the patterned medium in the comparative example 3.

As a result of the SEM observation, it was found out that the magnetic dots of the patterned medium in each of the examples 1, the comparative example 1, the comparative example 2, the comparative example 3, and the comparative example 5 were formed in a regular array with a dot pitch of about 17 nm. Meanwhile, it was found out that the magnetic dots of the patterned medium in the comparative example 4 were not formed in a regular array, since the dot pitch was not constant, and in a part thereof, a coalescence of mutual dots was observed.

Table 1 presents each of the coercive force Hc, the switching field distribution SFD, and the thermal fluctuation resistance index β obtained through the Kerr measurement, and the degree of order S of the hard magnetic recording layer 131 and the degree of order S* of the soft magnetic recording layer 133 obtained through the XRD evaluation.

TABLE 1

| | | | | | | Degree of | Degree of |
|---|---|---|---|---|---|---|---|
| | Material of | Material of | | Switching | Thermal | Order S of | Order S* of |
| | Soft Magnetic | Nonmagnetic | Coercive | Field | Fluctuation | Hard Magnetic | Soft Magnetic |
| | Recording | Intermediate | Force | Distribution | Resistance | Recording | Recording |
| | Layer | Layer | Hc [kOe] | SFD[%] | Index β | Layer | Layer |
| Example 1 | FePt | C | 10.1 | 7.1 | 299 | 0.82 | <0.2 |
| Example 1 | CoPt | C | 9.3 | 6.8 | 260 | 0.73 | <0.2 |
| Comparative | FePt | — | 18.8 | 42 | 295 | 0.82 | — |
| Example 1 | | | | | | | |
| Comparative | FePt | — | 8.9 | 40 | 130 | 0.7 | <0.2 |
| Example 2 | | | | | | | |
| Comparative | FePt | Pt | 5.1 | 55 | 72 | 0.51 | <0.2 |
| Example 3 | | | | | | | |
| Comparative | FePt | C | 8.2 | 32 | 150 | 0.58 | <0.2 |
| Example 4 | | | | | | | |
| Comparative | FePt | C | 8.5 | 19 | 151 | 0.59 | <0.2 |
| Example 5 | | | | | | | |

The switching field distribution SFD of the medium in each of the examples 1 was confirmed to be significantly reduced, when compared to the comparative example 1. It can be considered that an effect of forming the ECC medium by stacking the nonmagnetic intermediate layer 132 and the soft magnetic recording layer 133, remarkably appeared.

Further, when compared to the comparative example 2, it was found out that the switching field distribution SFD was significantly reduced and the thermal fluctuation resistance index β was significantly improved in the medium in each of the examples 1. It can be considered that this is because of an effect of suppressing the alloying of the hard magnetic recording layer 131 and the soft magnetic recording layer 133 and realizing the formation of ECC medium, by forming the nonmagnetic intermediate layer 132.

When compared to the comparative example 3, it was found out that the switching field distribution SFD was significantly reduced and the thermal fluctuation resistance index β was significantly improved in the medium in each of the examples 1. It can be considered that when Pt was used as the nonmagnetic intermediate layer 132, the hard magnetic recording layer 131, the nonmagnetic intermediate layer 132, and the soft magnetic recording layer 133 were alloyed by heating, resulting in that the magnetic properties deteriorated. Meanwhile, it can be considered that when C was used as the nonmagnetic intermediate layer 132, the alloying was suppressed, which realized the formation of ECC medium, resulting in that the magnetic properties were improved.

Note that when the nonmagnetic intermediate layer 132 used Pd, Ru, Cu, Ti, Re, Ir or Cu in the comparative example 3, a tendency similar to that of Pt was found.

When compared to the comparative example 4, it was found out that the switching field distribution SFD was significantly reduced and the thermal fluctuation resistance index β was significantly improved in the patterned medium in each of the examples 1. It can be considered that since the substrate 11 was heated before depositing the hard magnetic recording layer 131 in the comparative example 4, the array of dot structure was disordered, resulting in that the switching field distribution SFD was increased. Further, it can be considered that in the comparative example 4, a phase of a part of the hard magnetic recording layer 131 was disordered by the pattern processing, so that the degree of order S was lowered and the magnetic anisotropic energy density Ku was reduced, resulting in that the thermal fluctuation resistance index β was deteriorated.

When compared to the comparative example 5, it was found out that the switching field distribution SFD was significantly reduced and the thermal fluctuation resistance index β was significantly improved in the patterned medium in each of the examples 1. It can be considered that since the substrate 11 was heated before the pattern processing in the comparative example 5, a phase of a part of the hard magnetic recording layer 131 was disordered by the pattern processing, so that the degree of order S was lowered and the magnetic anisotropic energy density Ku was reduced, resulting in that the thermal fluctuation resistance index β was deteriorated.

### Example 2

Each of patterned media in which the heating temperature after the pattern processing was changed within a range of room temperature (absence of heating) to 700° C., was formed in the following manner. Each of the patterned media was formed in a similar manner to the example 1, except that the heating temperature after the pattern processing was changed within a range of room temperature (absence of heating) to 700° C.

As a result of the XRD evaluation, it was found out that the crystal grains of the hard magnetic recording layer 131 of each medium were oriented in the (001) plane. It was found out that in each medium, the nonmagnetic base layer 12 and the second nonmagnetic base layer 16 were oriented in the (100) plane. In each medium, the amorphous seed layer 17 was found out to be amorphous. The crystal grains of the hard magnetic recording layer 131 of each patterned medium in which the heating temperature was 400° C. or more, were found out to have the L1₀ structure. It was found out that the soft magnetic recording layer 133 of each patterned medium in which the heating temperature was less than 600° C. had the fcc structure.

As a result of the cross-section TEM observation, layer boundaries of the hard magnetic recording layer 131, the nonmagnetic intermediate layer 132, and the soft magnetic recording layer 133 in the perpendicular magnetic recording layer 13 of each patterned medium, were clearly observed, and thus the perpendicular magnetic recording layer 13 was found out to have a three-layered structure. As a result of the SEM observation, it was found out that the magnetic dots of each patterned medium were formed in a regular array with a dot pitch of about 17 nm. Note that a crack of the substrate 11 was observed in the patterned medium in which the temperature of the substrate 11 was 650° C. or more.

Table 2 presents each of the coercive force Hc, the switching field distribution SFD, and the thermal fluctuation resistance index β obtained through the Kerr measurement, and the degree of order S of the hard magnetic recording layer 131 and the degree of order S* of the soft magnetic recording layer 133 obtained through the XRD evaluation.

TABLE 2

| | | | | | Degree of | Degree of |
|---|---|---|---|---|---|---|
| | | | Switching | Thermal | Order S of | Order S* of |
| | Heating | Coercive | Field | Fluctuation | Hard Magnetic | Soft Magnetic |
| | Temperature | Force | Distribution | Resistance | Recording | Recording |
| | [° C.] | Hc[kOe] | SFD [%] | Index β | Layer | Layer |
| Comparative | R.T. | 0.1 | >100 | — | <0.2 | <0.2 |
| Example | (Room Temperature) | | | | | |
| Comparative | 300 | 0.8 | >100 | 35 | <0.2 | <0.2 |
| Example | | | | | | |
| Comparative | 350 | 0.9 | >100 | 40 | <0.2 | <0.2 |
| Example | | | | | | |
| Example 2 | 400 | 8.5 | 9.9 | 200 | 0.75 | <0.2 |
| Example 2 | 450 | 9.1 | 7.8 | 280 | 0.77 | <0.2 |
| Example 1 | 500 | 10.1 | 7.1 | 299 | 0.82 | <0.2 |
| Example 2 | 550 | 10.5 | 7.4 | 301 | 0.91 | <0.2 |
| Example 2 | 600 | 11.1 | 8.1 | 310 | 0.96 | <0.2 |
| Comparative | 650 | 13.8 | 17.1 | 215 | 0.79 | 0.4 |
| Example | | | | | | |

It was found out that the heating temperature of 400° C. or more was preferable, since the switching field distribution SFD was significantly reduced and the thermal fluctuation resistance index β was significantly improved. It can be considered that, this is because the ordered alloying of the hard magnetic recording layer 131 is caused by the heating at 400° C. or more.

### Example 3

Each of patterned media in which the heating temperature at the time of depositing the hard magnetic recording layer 131 was changed within a range of room temperature (absence of heating) to 300° C., was formed in the following manner. Each of the patterned media was formed in a similar manner to the example 1, except that the heating temperature at the time of the deposition was changed within a range of room temperature (absence of heating) to 300° C.

As a result of the XRD evaluation, it was found out that the crystal grains of the hard magnetic recording layer 131 of each medium were oriented in the (001) plane. It was found out that in each medium, the nonmagnetic base layer 12 and the second nonmagnetic base layer 16 were oriented in the (100) plane. In each medium, the amorphous seed layer 17 was found out to be amorphous. The crystal grains of the hard magnetic recording layer 131 of each medium were found out to have the L1₀ structure. It was found out that the soft magnetic recording layer 133 of each medium had the fcc structure.

As a result of the cross-section TEM observation, layer boundaries of the hard magnetic recording layer 131, the nonmagnetic intermediate layer 132, and the soft magnetic recording layer 133 in the perpendicular magnetic recording layer 13 of each patterned medium, were clearly observed, and thus the perpendicular magnetic recording layer 13 was found out to have a three-layered structure. As a result of the SEM observation, it was found out that the magnetic dots of the patterned medium in which the heating temperature at the time of depositing the hard magnetic recording layer 131 was 200° C. or less, were formed in a regular array with a dot pitch of about 17 nm. Meanwhile, it was found out that the magnetic dots of the patterned medium in which the heating temperature at the time of the deposition was 250° C. or more, were not formed in a regular array, since the dot pitch was not constant, and in a part thereof, a coalescence of mutual dots was observed.

Table 3 presents each of the coercive force Hc, the switching field distribution SFD, and the thermal fluctuation resistance index β obtained through the Kerr measurement, and the degree of order S of the hard magnetic recording layer 131 and the degree of order S* of the soft magnetic recording layer 133 obtained through the XRD evaluation.

TABLE 3

| | | | | | Degree of | Degree of |
|---|---|---|---|---|---|---|
| | | | Switching | Thermal | Order S of | Order S* of |
| | Heating | Coercive | Field | Fluctuation | Hard Magnetic | Soft Magnetic |
| | Temperature | Force | Distribution | Resistance | Recording | Recording |
| | [° C.] | Hc[kOe] | SFD [%] | Index β | Layer | Layer |
| Example 1 | R.T. | 10.1 | 7.1 | 299 | 0.82 | <0.2 |
| | (Room Temperature) | | | | | |
| Example 3 | 100 | 10.0 | 7.2 | 297 | 0.83 | <0.2 |
| Example 3 | 150 | 10.2 | 7.5 | 298 | 0.81 | <0.2 |
| Example 3 | 200 | 10.5 | 7.8 | 301 | 0.84 | <0.2 |
| Comparative | 250 | 11.2 | 20.1 | 302 | 0.85 | <0.2 |
| Example | | | | | | |
| Comparative | 300 | 11.1 | 22.3 | 300 | 0.84 | <0.2 |
| Example | | | | | | |

When the heating temperature is 200° C. or less, the switching field distribution SFD is significantly reduced and the thermal fluctuation resistance index β is significantly improved. It can be considered that this is because the magnetic dots maintain a regular array when the heating temperature at the time of depositing the hard magnetic recording layer 131 is 200° C. or less.

### Example 4

Each of patterned media in which the pressure of Ar gas when depositing the hard magnetic recording layer 131 was changed within a range of 1 to 14 Pa, was formed in the following manner. Each of the patterned media was formed in a similar manner to the example 1, except that the pressure of Ar gas when depositing the hard magnetic recording layer 131 was changed within a range of 1 to 14 Pa.

As a result of the XRD evaluation, it was found out that the crystal grains of the hard magnetic recording layer 131 of each medium were oriented in the (001) plane. It was found out that in each medium, the nonmagnetic base layer 12 and the second nonmagnetic base layer 16 were oriented in the (100) plane. In each medium, the amorphous seed layer 17 was found out to be amorphous. The crystal grains of the hard magnetic recording layer 131 of each patterned medium in which the deposition pressure was 4 Pa or more, were found out to have the L1₀ structure. It was found out that the soft magnetic recording layer 133 of each patterned medium had the fcc structure.

As a result of the cross-section TEM observation, layer boundaries of the hard magnetic recording layer 131, the nonmagnetic intermediate layer 132, and the soft magnetic recording layer 133 in the perpendicular magnetic recording layer 13 of each patterned medium, were clearly observed, and thus the perpendicular magnetic recording layer 13 was found out to have a three-layered structure. As a result of the SEM observation, it was found out that the magnetic dots of each patterned medium were formed in a regular array with a dot pitch of about 17 nm.

Table 4 presents each of the coercive force Hc, the switching field distribution SFD, and the thermal fluctuation resistance index β obtained through the Kerr measurement, and the degree of order S of the hard magnetic recording layer 131 and the degree of order S* of the soft magnetic recording layer 133 obtained through the XRD evaluation.

TABLE 4

| | | | | | Degree of | Degree of |
|---|---|---|---|---|---|---|
| | | | Switching | Thermal | Order S of | Order S* of |
| | Deposition | Coercive | Field | Fluctuation | Hard Magnetic | Soft Magnetic |
| | Pressure | Force | Distribution | Resistance | Recording | Recording |
| | [Pa] | Hc[kOe] | SFD [%] | Index β | Layer | Layer |
| Comparative | 1 | 0.8 | >100 | — | 0.3 | <0.2 |
| Example | | | | | | |
| Comparative | 2 | 3.1 | 65 | 83 | 0.5 | <0.2 |
| Example | | | | | | |
| Example 4 | 4 | 8.5 | 9.6 | 250 | 0.65 | <0.2 |
| Example 4 | 5 | 9.5 | 7.4 | 267 | 0.73 | <0.2 |
| Example 1 | 8 | 10.1 | 7.1 | 299 | 0.82 | <0.2 |
| Example 4 | 10 | 10.2 | 7.3 | 302 | 0.85 | <0.2 |
| Example 4 | 12 | 10.6 | 8.9 | 305 | 0.85 | <0.2 |
| Comparative | 14 | 9.6 | 14.2 | 131 | 0.84 | <0.2 |
| Example | | | | | | |

It was found out that when the pressure of Ar gas at the time of depositing the hard magnetic recording layer 131 was within a range of 4 Pa to 12 Pa, the switching field distribution SFD was significantly reduced and the thermal fluctuation resistance index β was significantly improved. It can be considered that when the pressure of Ar gas at the time of depositing the hard magnetic recording layer 131 is less than 4 Pa, the ordered alloying is difficult to be caused. It can be considered that when the pressure of Ar gas at the time of depositing the hard magnetic recording layer 131 exceeds 12 Pa, the film density is lowered to reduce the magnetic anisotropic energy density Ku.

### Example 5

Each of patterned media in which the pressure of Ar gas when depositing the soft magnetic recording layer 133 was changed within a range of 0.1 to 4 Pa, was formed in the following manner. Each of the patterned media was formed in a similar manner to the example 1, except that the pressure of Ar gas when depositing the soft magnetic recording layer 133 was changed within a range of 0.1 to 4 Pa.

As a result of the XRD evaluation, it was found out that the crystal grains of the hard magnetic recording layer 131 of each medium were oriented in the (001) plane. It was found out that in each medium, the nonmagnetic base layer 12 and the second nonmagnetic base layer 16 were oriented in the (100) plane. In each medium, the amorphous seed layer 17 was found out to be amorphous. The crystal grains of the hard magnetic recording layer 131 of each medium were found out to have the L1₀ structure. It was found out that the soft magnetic recording layer 133 of each patterned medium in which the deposition pressure was less than 3 Pa had the fcc structure.

As a result of the cross-section TEM observation, layer boundaries of the hard magnetic recording layer 131, the nonmagnetic intermediate layer 132, and the soft magnetic recording layer 133 in the perpendicular magnetic recording layer 13 of each patterned medium, were clearly observed, and thus the perpendicular magnetic recording layer 13 was found out to have a three-layered structure. As a result of the SEM observation, it was found out that the magnetic dots of each patterned medium were formed in a regular array with a dot pitch of about 17 nm.

Table 5 presents each of the coercive force Hc, the switching field distribution SFD, and the thermal fluctuation resistance index β obtained through the Kerr measurement, and the degree of order S of the hard magnetic recording layer 131 and the degree of order S* of the soft magnetic recording layer 133 obtained through the XRD evaluation.

TABLE 5

| | | | | | Degree of | Degree of |
|---|---|---|---|---|---|---|
| | | | Switching | Thermal | Order S of | Order S* of |
| | Deposition | Coercive | Field | Fluctuation | Hard Magnetic | Soft Magnetic |
| | Pressure | Force | Distribution | Resistance | Recording | Recording |
| | [Pa] | Hc[kOe] | SFD [%] | Index β | Layer | Layer |
| Example 5 | 0.1 | 9.8 | 6.9 | 297 | 0.82 | <0.2 |
| Example 1 | 0.7 | 10.1 | 7.1 | 299 | 0.82 | <0.2 |
| Example 5 | 1 | 10.5 | 7.5 | 300 | 0.82 | <0.2 |
| Example 5 | 2 | 10.9 | 7.8 | 302 | 0.82 | <0.2 |
| Comparative | 3 | 14.8 | 21 | 303 | 0.82 | 0.5 |
| Example | | | | | | |
| Comparative | 4 | 15.1 | 28 | 305 | 0.82 | 0.6 |
| Example | | | | | | |

It was found out that the pressure of Ar gas when depositing the soft magnetic recording layer 133 within a range of 0.1 Pa to 2 Pa was preferable, since the switching field distribution SFD was significantly reduced. It can be considered that when the pressure of Ar gas at the time of depositing the soft magnetic recording layer 133 is within a range of 0.1 Pa to 2 Pa, the ordered alloying of the soft magnetic recording layer 133 is difficult to be caused, and the anisotropic magnetic field Hk is sufficiently small, resulting in that the effect of forming the ECC medium appears. Meanwhile, it can be considered that when the pressure of Ar gas at the time of depositing the soft magnetic recording layer 133 exceeds 2 Pa, the ordered alloying of the soft magnetic recording layer 133 proceeds, and the anisotropic magnetic field Hk is increased, resulting in that the effect of forming the ECC medium is reduced.

### Example 6

A patterned medium in which the nonmagnetic base layer 12 was changed to one made of TiN, was formed in the following manner. The patterned medium was formed in a similar manner to the example 1, except that the nonmagnetic base layer 12 was changed to one made of TiN. Regarding the deposition of TiN, the deposition was conducted by a DC sputtering method using a TiN target.

As a result of the XRD evaluation, it was found out that the crystal grains of the hard magnetic recording layer 131 were oriented in the (001) plane. It was found out that the nonmagnetic base layer 12 and the second nonmagnetic base layer 16 were oriented in the (100) plane. The amorphous seed layer 17 was found out to be amorphous. The crystal grains of the hard magnetic recording layer 131 were found out to have the L1₀ structure. It was found out that the soft magnetic recording layer 133 had the fcc structure.

As a result of the cross-section TEM observation, layer boundaries of the hard magnetic recording layer 131, the nonmagnetic intermediate layer 132, and the soft magnetic recording layer 133 in the perpendicular magnetic recording layer 13 were clearly observed, and thus the perpendicular magnetic recording layer 13 was found out to have a three-layered structure. As a result of the SEM observation, it was found out that the magnetic dots of each patterned medium were formed in a regular array with a dot pitch of about 17 nm.

Table 6 presents each of the coercive force Hc, the switching field distribution SFD, and the thermal fluctuation resistance index β obtained through the Kerr measurement, and the degree of order S of the hard magnetic recording layer 131 and the degree of order S* of the soft magnetic recording layer 133 obtained through the XRD evaluation.

TABLE 6

| | | | | | Degree of | Degree of |
|---|---|---|---|---|---|---|
| | Material of | | Switching | Thermal | Order S of | Order S* of |
| | Nonmagnetic | Coercive | Field | Fluctuation | Hard Magnetic | Soft Magnetic |
| | Intermediate | Force | Distribution | Resistance | Recording | Recording |
| | Layer | Hc[kOe] | SFD [%] | Index β | Layer | Layer |
| Example 6 | TiN | 10.2 | 7.2 | 290 | 0.8 | <0.2 |
| Example 1 | C | 10.1 | 7.1 | 299 | 0.82 | <0.2 |

It was found out that also when TiN was used as the nonmagnetic base layer 12, the switching field distribution SFD was significantly reduced and the thermal fluctuation resistance index β was significantly improved, in a similar manner.

### Example 7

Each of patterned media in which the nonmagnetic intermediate layer 132 was changed to one made of TiC, was formed in the following manner. Each of the patterned media was formed in a similar manner to the example 1, except that the nonmagnetic intermediate layer 132 was changed to one made of TiC. Regarding the deposition of TiC, the deposition was conducted by a DC sputtering method using each of TiC targets in which the C composition was changed within a range of 40 to 100 atom %. Patterned media using SiC, TaC, and WC, respectively, instead of TiC, were also formed in a similar manner.

As a result of the XRD evaluation, it was found out that the crystal grains of the hard magnetic recording layer 131 of each medium were oriented in the (001) plane. It was found out that the nonmagnetic base layer 12 and the second nonmagnetic base layer 16 of each medium were oriented in the (100) plane. In each medium, the amorphous seed layer 17 was found out to be amorphous. The crystal grains of the hard magnetic recording layer 131 of the medium in which the C composition in the nonmagnetic intermediate layer 132 was 10 atom % or more, were found out to have the L1₀ structure. It was found out that the soft magnetic recording layer 133 of each medium had the fcc structure.

As a result of the cross-section TEM observation, layer boundaries of the hard magnetic recording layer 131, the nonmagnetic intermediate layer 132, and the soft magnetic recording layer 133 in the perpendicular magnetic recording layer 13 of the patterned medium in which the C composition in the nonmagnetic intermediate layer 132 was 50 atom % or more, were clearly observed, and thus the perpendicular magnetic recording layer 13 was found out to have a three-layered structure. Meanwhile, in the patterned medium in which the C composition was less than 50 atom %, a layer boundary of the hard magnetic recording layer 131 and the soft magnetic recording layer 133 was unclear. As a result of the SEM observation, it was found out that the magnetic dots of each patterned medium were formed in a regular array with a dot pitch of about 17 nm.

Table 7 presents each of the C composition in the nonmagnetic intermediate layer 132 obtained through the XPS measurement, the coercive force Hc, the switching field distribution SFD, and the thermal fluctuation resistance index β obtained through the Kerr measurement, and the degree of order S of the hard magnetic recording layer 131 and the degree of order S* of the soft magnetic recording layer 133 obtained through the XRD evaluation.

TABLE 7

| | | | | | Degree of | Degree of |
|---|---|---|---|---|---|---|
| | | | Switching | Thermal | Order S of | Order S* of |
| | C | Coercive | Field | Fluctuation | Hard Magnetic | Soft Magnetic |
| | Composition | Force | Distribution | Resistance | Recording | Recording |
| | [atom %] | Hc[kOe] | SFD [%] | Index β | Layer | Layer |
| Comparative | 0 | 7.1 | 40 | 140 | 0.5 | <0.2 |
| Example | | | | | | |
| Comparative | 10 | 8.5 | 42 | 180 | 0.61 | <0.2 |
| Example | | | | | | |
| Comparative | 20 | 9.0 | 18 | 203 | 0.65 | <0.2 |
| Example | | | | | | |
| Comparative | 30 | 10.9 | 16.3 | 250 | 0.7 | <0.2 |
| Example | | | | | | |
| Example 7 | 50 | 9.5 | 6.8 | 310 | 0.9 | <0.2 |
| Example 7 | 80 | 9.8 | 6.5 | 305 | 0.89 | <0.2 |
| Example 7 | 90 | 9.9 | 6.9 | 300 | 0.81 | <0.2 |
| Example 1 | 100 | 10.1 | 7.1 | 299 | 0.82 | <0.2 |

It was found out that the C composition in TiC of 50 atom % or more was preferable, since the switching field distribution SFD was significantly reduced. It can be considered that this is because, if the C composition is within a range of 50 atom % or more, the alloying of the soft magnetic recording layer 133 and the hard magnetic recording layer 131 can be suppressed. A similar tendency was found also when the nonmagnetic intermediate layer 132 was made of TaC, SiC, or WC.

### Example 8

Each of patterned media in which the nonmagnetic intermediate layer 132 was changed to one made of TiN, was formed in the following manner. Each of the patterned media was formed in a similar manner to the example 1, except that the nonmagnetic intermediate layer 132 was changed to one made of TiN. The deposition was conducted using a Ti target by a reactive sputtering method in which Ar/N2 mixed gas was used as sputtering gas. The N composition in TiN was controlled by changing an Ar/N2 ratio in the sputtering gas. Patterned media using SiN, TaN, and WN, respectively, instead of TiN, were also formed in a similar manner.

As a result of the XRD evaluation, it was found out that the crystal grains of the hard magnetic recording layer 131 of each medium were oriented in the (001) plane. It was found out that the nonmagnetic base layer 12 and the second nonmagnetic base layer 16 of each medium were oriented in the (100) plane. In each medium, the amorphous seed layer 17 was found out to be amorphous. The crystal grains of the hard magnetic recording layer 131 of the medium in which the N composition in the nonmagnetic intermediate layer 132 was 10 atom % or more, were found out to have the L1₀ structure. It was found out that the soft magnetic recording layer 133 of each medium had the fcc structure.

As a result of the cross-section TEM observation, layer boundaries of the hard magnetic recording layer 131, the nonmagnetic intermediate layer 132, and the soft magnetic recording layer 133 in the perpendicular magnetic recording layer 13 of the patterned medium in which the N composition in the nonmagnetic intermediate layer 132 was 30 atom % or more, were clearly observed, and thus the perpendicular magnetic recording layer 13 was found out to have a three-layered structure. Meanwhile, in the patterned medium in which the N composition was less than 30 atom %, a layer boundary of the hard magnetic recording layer 131 and the soft magnetic recording layer 133 was unclear. As a result of the SEM observation, it was found out that the magnetic dots of each patterned medium were formed in a regular array with a dot pitch of about 17 nm.

Table 8 presents each of the N composition in the nonmagnetic intermediate layer 132 obtained through the XPS measurement, the coercive force Hc, the switching field distribution SFD, and the thermal fluctuation resistance index β obtained through the Kerr measurement, and the degree of order S of the hard magnetic recording layer 131 and the degree of order S* of the soft magnetic recording layer 133 obtained through the XRD evaluation.

TABLE 8

| | | | | | Degree of | Degree of |
|---|---|---|---|---|---|---|
| | | | Switching | Thermal | Order S of | Order S* of |
| | N | Coercive | Field | Fluctuation | Hard Magnetic | Soft Magnetic |
| | Composition | Force | Distribution | Resistance | Recording | Recording |
| | [atom %] | Hc[kOe] | SFD [%] | Index β | Layer | Layer |
| Comparative | 0 | 7.1 | 40 | 140 | 0.5 | <0.2 |
| Example | | | | | | |
| Comparative | 10 | 7.3 | 21 | 201 | 0.68 | <0.2 |
| Example | | | | | | |
| Comparative | 20 | 8.5 | 14.9 | 210 | 0.7 | <0.2 |
| Example | | | | | | |
| Example 8 | 30 | 8.9 | 7.5 | 289 | 0.75 | <0.2 |
| Example 8 | 40 | 9.1 | 7.3 | 296 | 0.82 | <0.2 |
| Example 8 | 50 | 9.5 | 6.8 | 310 | 0.88 | <0.2 |
| Example 8 | 60 | 9.2 | 6.2 | 301 | 0.85 | <0.2 |
| Comparative | 70 | 6.2 | 18 | 120 | 0.5 | <0.2 |
| Example | | | | | | |

It was found out that the N composition in TiN within a range of 30 to 60 atom % was preferable, since the switching field distribution SFD was significantly reduced. It can be considered that this is because, if the N composition is within a range of 30 atom % or more, the alloying of the soft magnetic recording layer 133 and the hard magnetic recording layer 131 can be suppressed. Meanwhile, it can be considered that if the N composition exceeded 60 atom %, the magnetic anisotropic energy density Ku of the hard magnetic recording layer was reduced, resulting in that the thermal fluctuation resistance index β was deteriorated. A similar tendency was found also when TaN, SiN, or WN was used as the nonmagnetic intermediate layer 132.

### Example 9

Each of patterned media in which the Pt composition in the soft magnetic recording layer 133 was changed, was formed in the following manner. Each of the patterned media was formed in a similar manner to the example 1, except that the soft magnetic recording layer 133 was changed to one made of a Co—Pt alloy. Regarding the deposition of the Co—Pt alloy, the deposition was conducted by a DC sputtering method by using each of Co—Pt targets in which the Pt composition was changed within a range of 0 to 100 atom %. A patterned medium in which the soft magnetic recording layer 133 was changed to one made of an Fe—Pt alloy, was also formed in a similar manner.

As a result of the XRD evaluation, it was found out that the crystal grains of the hard magnetic recording layer 131 of each medium were oriented in the (001) plane. It was found out that the nonmagnetic base layer 12 and the second nonmagnetic base layer 16 of each medium were oriented in the (100) plane. In each medium, the amorphous seed layer 17 was found out to be amorphous. The crystal grains of the hard magnetic recording layer 131 of each medium were found out to have the L1₀ structure. It was found out that the crystal grains of the soft magnetic recording layer 133 in which the Pt composition was 0 to 30% had the fcp structure, and the crystal grains of the soft magnetic recording layer 133 in which the Pt composition was 40% or more, had the fcc structure.

As a result of the cross-section TEM observation, layer boundaries of the hard magnetic recording layer 131, the nonmagnetic intermediate layer 132, and the soft magnetic recording layer 133 in the perpendicular magnetic recording layer 13 of each patterned medium were clearly observed, and thus the perpendicular magnetic recording layer 13 was found out to have a three-layered structure. As a result of the SEM observation, it was found out that the magnetic dots of each patterned medium were formed in a regular array with a dot pitch of about 17 nm.

Table 9 presents each of the Pt composition in the soft magnetic recording layer 133 obtained through the XPS measurement, the coercive force Hc, the switching field distribution SFD, and the thermal fluctuation resistance index β obtained through the Kerr measurement, and the degree of order S of the hard magnetic recording layer 131 and the degree of order S* of the soft magnetic recording layer 133 obtained through the XRD evaluation.

TABLE 9

| | | | | | Degree of | Degree of |
|---|---|---|---|---|---|---|
| | | | Switching | Thermal | Order S of | Order S* of |
| | Pt | Coercive | Field | Fluctuation | Hard Magnetic | Soft Magnetic |
| | Composition | Force | Distribution | Resistance | Recording | Recording |
| | [atom %] | Hc[kOe] | SFD [%] | Index β | Layer | Layer |
| Example 9 | 0 | 11.3 | 9.8 | 299 | 0.82 | — |
| Comparative | 10 | 11.5 | 15 | 308 | 0.81 | <0.2 |
| Example | | | | | | |
| Comparative | 20 | 14.8 | 14 | 310 | 0.82 | <0.2 |
| Example | | | | | | |
| Comparative | 30 | 11.6 | 15 | 302 | 0.8 | <0.2 |
| Example | | | | | | |
| Example 9 | 40 | 10.0 | 9.0 | 300 | 0.81 | <0.2 |
| Example 1 | 50 | 10.1 | 7.1 | 299 | 0.82 | <0.2 |
| Example 9 | 60 | 10.8 | 8.5 | 300 | 0.83 | <0.2 |
| Comparative | 70 | 11.6 | 20 | 297 | 0.81 | <0.2 |
| Example | | | | | | |

It was found out that the Pt composition in the Co—Pt alloy of 0% or within a range of 40 to 60 atom % was preferable, since the switching field distribution SFD was significantly reduced. It can be considered that this is because, when the Pt composition was 0% or within a range of 40 to 60 atom %, the anisotropic magnetic field Hk of the soft magnetic recording layer 133 was sufficiently small, resulting in that the effect of forming the ECC medium appeared. Meanwhile, it can be considered that when the Pt composition was within a range of greater than 0% and less than 40 atom %, the anisotropic magnetic field Hk of the Co—Pt alloy increased and the effect of forming the ECC medium was reduced, resulting in that the switching field distribution SFD was increased. It can be considered that when the Pt composition exceeded 60 atom %, the Ms of the soft magnetic recording layer 133 was extremely reduced, which reduced the effect of forming the ECC medium, resulting in that the switching field distribution SFD was increased. A similar tendency was found also in the case of Fe—Pt alloy.

Note that it can be considered that the Pt composition in the vicinity of 0% (about 5%, for example) is also allowable, similar to the case where the composition is 0%.

### Example 10

Each of media in which Si was added to the soft magnetic recording layer 133 was formed in the following manner. Each of the media was formed in a similar manner to the example 1, except that the soft magnetic recording layer 133 was changed to one made of a Co—Si alloy. Regarding the deposition of the Co—Si alloy, the deposition was conducted by a DC sputtering method using each of Co—Si targets in which the Si composition was changed within a range of 0 to 20 atom %. In like manner, media in which the composing material of the soft magnetic recording layer 133 was changed to each of Co—Al, Co—Mg, Co—Ti, and Co—Cr, were respectively formed.

As a result of the XRD evaluation, it was found out that the crystal grains of the hard magnetic recording layer 131 of each medium were oriented in the (001) plane. It was found out that the nonmagnetic base layer 12 and the second nonmagnetic base layer 16 of each medium were oriented in the (100) plane. In each medium, the amorphous seed layer 17 was found out to be amorphous. The crystal grains of the hard magnetic recording layer 131 of each medium were found out to have the L1₀ structure. It was found out that in each medium, the soft magnetic recording layer 133 had the fcp structure.

As a result of the cross-section TEM observation, layer boundaries of the hard magnetic recording layer 131, the nonmagnetic intermediate layer 132, and the soft magnetic recording layer 133 in the perpendicular magnetic recording layer 13 of each patterned medium were clearly observed, and thus the perpendicular magnetic recording layer 13 was found out to have a three-layered structure. As a result of the SEM observation, it was found out that the magnetic dots of each patterned medium were formed in a regular array with a dot pitch of about 17 nm. As a result of the XPS measurement, a part of Si in the soft magnetic recording layer 133 was found out to be oxidized. The same applied to the case of Al, Mg, Cr or Ti.

Table 10 presents each of the composition of Si, Al, Mg, Ti or Cr in the soft magnetic recording layer 133 obtained through the XPS measurement, the coercive force Hc, the switching field distribution SFD, and the thermal fluctuation resistance index β obtained through the Kerr measurement, and the degree of order S of the hard magnetic recording layer 131 obtained through the XRD evaluation.

TABLE 10

| | | | | | | Degree of | Degree of |
|---|---|---|---|---|---|---|---|
| | | | | Switching | Thermal | Order S of | Order S* of |
| | | Addition | Coercive | Field | Fluctuation | Hard Magnetic | Soft Magnetic |
| | Additive | Amount | Force | Distribution | Resistance | Recording | Recording |
| | Element | [atom %] | Hc[kOe] | SFD [%] | Index β | Layer | Layer |
| Example 9 | — | 0 | 11.3 | 9.8 | 299 | 0.82 | — |
| Example 10 | Si | 1 | 8.5 | 7.2 | 299 | 0.82 | — |
| Example 10 | Si | 3 | 8.3 | 6.2 | 297 | 0.81 | — |
| Example 10 | Si | 5 | 8.1 | 6.1 | 299 | 0.82 | — |
| Example 10 | Si | 8 | 8.3 | 7.8 | 298 | 0.82 | — |
| Example 10 | Si | 10 | 8.5 | 7.9 | 299 | 0.82 | — |
| Comparative | Si | 12 | 9.5 | 15.6 | 300 | 0.82 | — |
| Example | | | | | | | |
| Example 10 | Al | 1 | 8.7 | 7.6 | 301 | 0.82 | — |
| Example 10 | Al | 3 | 8.5 | 6.7 | 300 | 0.81 | — |
| Example 10 | Al | 5 | 8.1 | 6.4 | 301 | 0.82 | — |
| Example 10 | Al | 8 | 8.6 | 8.0 | 298 | 0.82 | — |
| Example 10 | Al | 10 | 8.7 | 9.1 | 299 | 0.82 | — |
| Comparative | Al | 12 | 9.5 | 15.3 | 300 | 0.82 | — |
| Example | | | | | | | |
| Example 10 | Mg | 1 | 8.5 | 8.0 | 299 | 0.82 | — |
| Example 10 | Mg | 3 | 8.3 | 7.0 | 297 | 0.81 | — |
| Example 10 | Mg | 5 | 8.1 | 7.1 | 301 | 0.82 | — |
| Example 10 | Mg | 8 | 8.3 | 7.8 | 300 | 0.82 | — |
| Example 10 | Mg | 10 | 8.5 | 8.3 | 299 | 0.82 | — |
| Comparative | Mg | 12 | 9.5 | 16.2 | 297 | 0.82 | — |
| Example | | | | | | | |
| Example 10 | Ti | 1 | 8.5 | 8.3 | 296 | 0.82 | — |
| Example 10 | Ti | 3 | 8.2 | 6.9 | 297 | 0.81 | — |
| Example 10 | Ti | 5 | 8.1 | 6.8 | 296 | 0.82 | — |
| Example 10 | Ti | 8 | 8.0 | 8.4 | 300 | 0.82 | — |
| Example 10 | Ti | 10 | 8.5 | 9.0 | 299 | 0.82 | — |
| Comparative | Ti | 12 | 10.1 | 18.6 | 301 | 0.82 | — |
| Example | | | | | | | |
| Example 10 | Cr | 1 | 9.1 | 7.1 | 300 | 0.82 | — |
| Example 10 | Cr | 3 | 8.9 | 6.3 | 297 | 0.81 | — |
| Example 10 | Cr | 5 | 8.5 | 6.2 | 302 | 0.82 | — |
| Example 10 | Cr | 8 | 8.4 | 7.5 | 298 | 0.82 | — |
| Example 10 | Cr | 10 | 8.8 | 8.7 | 297 | 0.82 | — |
| Comparative | | 12 | 9.5 | 14.6 | 300 | 0.82 | — |
| Example | | | | | | | |

It was found out that the Si composition within a range of 1 to 10 atom % was preferable, since the switching field distribution SFD was significantly reduced. It can be considered that this is because the oxidation of C was suppressed by the addition of Si, resulting in that the effect of forming the ECC medium was increased. Meanwhile, it can be considered that if the Si composition exceeded 10 atom %, the magnetic properties of the soft magnetic recording layer 133 deteriorated, resulting in that the switching field distribution SFD was increased. A similar tendency was found also when Al, Mg, Cr, or Ti was added.

### Example 11

Each of patterned media in which the film thickness of the nonmagnetic base layer 12 was changed, was formed in the following manner. Each of the patterned media was formed in a similar manner to the example 1, except that the thickness of the nonmagnetic base layer 12 was changed within a range of 0 to 2.5 nm.

As a result of the XRD evaluation, it was found out that the crystal grains of the hard magnetic recording layer 131 of each medium were oriented in the (001) plane. It was found out that the nonmagnetic base layer 12 and the second nonmagnetic base layer 16 of each medium were oriented in the (100) plane. In each medium, the amorphous seed layer 17 was found out to be amorphous. The crystal grains of the hard magnetic recording layer 131 of each medium were found out to have the L1₀ structure. It was found out that in each medium, the soft magnetic recording layer 133 had the fcc structure.

As a result of the cross-section TEM observation, layer boundaries of the hard magnetic recording layer 131, the nonmagnetic intermediate layer 132, and the soft magnetic recording layer 133 in the perpendicular magnetic recording layer 13 of the patterned medium in which the film thickness of the nonmagnetic intermediate layer 132 was 0.2 nm or more, were clearly observed, and thus the perpendicular magnetic recording layer 13 was found out to have a three-layered structure. Meanwhile, in the patterned medium in which the film thickness of the nonmagnetic intermediate layer 132 was less than 0.2 nm, a layer boundary of the hard magnetic recording layer 131 and the soft magnetic recording layer 133 was unclear. As a result of the SEM observation, it was found out that the magnetic dots of each patterned medium were formed in a regular array with a dot pitch of about 17 nm.

Table 11 presents each of the film thickness of the nonmagnetic intermediate layer 132, the coercive force Hc, the switching field distribution SFD, and the thermal fluctuation resistance index β obtained through the Kerr measurement, and the degree of order S of the hard magnetic recording layer 131 and the degree of order S* of the soft magnetic recording layer 133 obtained through the XRD evaluation.

TABLE 11

| | Film | | | | Degree of | Degree of |
|---|---|---|---|---|---|---|
| | Thickness of | | Switching | Thermal | Order S of | Order S* of |
| | Nonmagnetic | Coercive | Field | Fluctuation | Hard Magnetic | Soft Magnetic |
| | Intermediate | Force | Distribution | Resistance | Recording | Recording |
| | Layer [nm] | Hc[kOe] | SFD [%] | Index β | Layer | Layer |
| Comparative | 0 | 8.9 | 40 | 130 | 0.7 | <0.2 |
| Example 2 | | | | | | |
| Comparative | 0.1 | 9 | .5 | 142 | 0.7 | <0.2 |
| Example | | | | | | |
| Example 11 | 0.2 | 11.1 | 8.5 | 290 | 0.8 | <0.2 |
| Example 11 | 0.5 | 10.6 | 6.7 | 300 | 0.8 | <0.2 |
| Example 1 | 1 | 10.1 | 7.1 | 299 | 0.82 | <0.2 |
| Example 11 | 1.5 | 10.3 | 7.3 | 298 | 0.81 | <0.2 |
| Example 11 | 2 | 10.9 | 8.6 | 298 | 0.82 | <0.2 |
| Comparative | 2.5 | 12.8 | 30 | 301 | 0.81 | <0.2 |
| Example | | | | | | |

It was found out that the film thickness of the nonmagnetic intermediate layer 132 within a range of 0.2 to 2 nm was preferable, since the switching field distribution SFD was significantly reduced. It can be considered that this is because, if the film thickness of the nonmagnetic intermediate layer 132 is within a range of 0.2 to 2 nm, it is possible to realize the formation of ECC medium. Meanwhile, if the film thickness of the nonmagnetic intermediate layer 132 exceeds 2 nm, the exchange coupling force between the hard magnetic recording layer 131 and the soft magnetic recording layer 133 is extremely weakened, resulting in that the formation of ECC medium cannot be realized. It can be considered that if the film thickness of the nonmagnetic intermediate layer 132 is less than 0.2 nm, the alloying of the hard magnetic recording layer 131 and the soft magnetic recording layer 133 is caused, resulting in that the formation of ECC medium cannot be realized.

### Example 12

A patterned medium in which the nonmagnetic intermediate layer 132 was changed to one made of ZnO, was formed in the following manner. The patterned medium was formed in a similar manner to the example 1, except that the nonmagnetic intermediate layer 132 was changed to one made of ZnO. Regarding the deposition of the nonmagnetic intermediate layer 132, the deposition was conducted by a DC sputtering method using a target obtained by adding 2 mass % of Al₂O₃ to ZnO.

As a result of the XRD evaluation, it was found out that the crystal grains of the hard magnetic recording layer 131 were oriented in the (001) plane. It was found out that the nonmagnetic base layer 12 and the second nonmagnetic base layer 16 were oriented in the (100) plane. The amorphous seed layer 17 was found out to be amorphous. It was found out that the soft magnetic recording layer 133 had the fcc structure.

As a result of the cross-section TEM observation, layer boundaries of the hard magnetic recording layer 131, the nonmagnetic intermediate layer 132, and the soft magnetic recording layer 133 in the perpendicular magnetic recording layer 13 were clearly observed, and thus the perpendicular magnetic recording layer 13 was found out to have a three-layered structure. It was found out that the magnetic dots were formed in a regular array with a dot pitch of about 17 nm.

Table 12 presents each of the coercive force Hc, the switching field distribution SFD, and the thermal fluctuation resistance index β obtained through the Kerr measurement, and the degree of order S of the hard magnetic recording layer 131 and the degree of order S* of the soft magnetic recording layer 133 obtained through the XRD evaluation.

TABLE 12

| | | | | | Degree of | Degree of |
|---|---|---|---|---|---|---|
| | Material of | | Switching | Thermal | Order S of | Order S* of |
| | Nonmagnetic | Coercive | Field | Fluctuation | Hard Magnetic | Soft Magnetic |
| | Intermediate | Force | Distribution | Resistance | Recording | Recording |
| | Layer | Hc[kOe] | SFD [%] | Index β | Layer | Layer |
| Example 12 | ZnO | 9.7 | 5.8 | 270 | 0.80 | <0.2 |
| Example 1 | C | 10.1 | 7.1 | 299 | 0.82 | <0.2 |

It was found out that the use of ZnO as the nonmagnetic intermediate layer 132 was preferable, similar to the case of using C, since the switching field distribution SFD and the thermal fluctuation resistance were good.

### Summary of Examples

Hereinafter, results of the examples will be summarized.

### 1. Nonmagnetic Intermediate Layer 132

(1) It was proved that C (Example 1), nitrides (TiN, SiN, TaN, WN: Examples 6 and 8), carbides (TiC, SiC, TaC, WC: Example 7), and ZnO (Example 12) were useful as materials of the nonmagnetic intermediate layer 132.

By using these materials, it was possible to reduce the switching field distribution SFD, compared to not only a case where the nonmagnetic intermediate layer 132 itself was not used (Comparative Examples 2 and 3), but also a case where, for example, Pt was used as the nonmagnetic intermediate layer 132 (Comparative Example 3).

(2) It is preferable that the component proportion of nitrogen in the nitride is 30 to 60 atom %, and the component proportion of carbon in the carbide is 50 to 100 atom % (Examples 7 and 8).
(3) It is preferable that the film thickness of the nonmagnetic intermediate layer 132 is about 0.2 to 2 nm (Example 11).

### 2. Soft Magnetic Recording Layer 133

(1) The composition proportion of Pt in the soft magnetic recording layer 133 is preferably 0 (to about 5 atom %), or 40 to 60 atom % (Example 9).
(2) It is preferable to add Si, Al, Mg, Ti, or Cr to the soft magnetic recording layer 133 (Example 10).
(3) The pressure of rare gas when performing deposition (sputtering) of the soft magnetic recording layer 133 is preferably 0.1 to 2 Pa (Example 5).

### 3. Hard Magnetic Recording Layer 131

(1) The temperature when performing deposition (sputtering) of the hard magnetic recording layer 131 is preferably 200° C. or less (Example 3).
(2) The pressure of rare gas when performing deposition (sputtering) of the hard magnetic recording layer 131 is preferably 4 to 12 Pa (Example 4).

### 4. Heat Treatment of Substrate 11

(1) It is preferable that the heat treatment (heating) of the substrate 11 is conducted after the formation and the pattern processing of the perpendicular magnetic recording layer 13 (the hard magnetic recording layer 131, the nonmagnetic intermediate layer 132, and the soft magnetic recording layer 133) (Example 1, Comparative Examples 4 and 5).
(2) The temperature of the heat treatment of the substrate 11 is preferably 400 to 600° C. (Example 2).

As described above, the patterned medium reducing the switching field distribution for each magnetic dot, having an excellent thermal fluctuation resistance, and capable of realizing a high-density recording, is obtained.

Although the above-described embodiments described the patterned medium, the technique of the embodiments can also be applied to a general magnetic recording medium.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic recording medium, comprising:
a substrate;
a nonmagnetic base layer disposed on the substrate;
a perpendicular magnetic recording layer disposed on the nonmagnetic base layer, having a hard magnetic recording layer, a nonmagnetic intermediate layer, and a soft magnetic recording layer, and divided into mutually separated plural regions; and
a protective layer disposed on the perpendicular magnetic recording layer,
the hard magnetic recording layer having an easy magnetization axis directed to a stack direction of the hard magnetic recording layer, and
the nonmagnetic intermediate layer including one of C, ZnO, a carbide of Si, Ti, Ta or W, and a nitride of Si, Ti, Ta or W.

2. The magnetic recording medium of claim 1, wherein the nonmagnetic intermediate layer contains carbon of not less than 50 atom % nor more than 100 atom %.

3. The magnetic recording medium of claim 1,
wherein the nonmagnetic intermediate layer contains nitrogen of not less than 30 atom % nor more than 80 atom %.

4. The magnetic recording medium of claim 1,
wherein the soft magnetic recording layer contains any one of Co, Fe, a Co—Pt alloy, and an Fe—Pt alloy.

5. The magnetic recording medium of claim 4,
wherein the soft magnetic recording layer contains a Co—Pt alloy or an Fe—Pt alloy having an fcc structure and having a Pt composition of not less than 40 atom % nor more than 70 atom %.

6. The magnetic recording medium of claim 1,
wherein the soft magnetic recording layer contains at least any one of Si, Ti, Al, Cr, and Mg of not less than 1 atom % nor more than 10 atom %.

7. The magnetic recording medium of claim 1,
wherein the hard magnetic recording layer contains an alloy material containing at least one of Fe and Co and at least one of Pt and Pd, having an L1₀ structure, and oriented in a (001) plane.

8. The magnetic recording medium of claim 1,
wherein the nonmagnetic base layer contains MgO or TiN.

9. The magnetic recording medium of claim 1, further comprising
a second nonmagnetic base layer disposed between the substrate and the nonmagnetic base layer, and containing Cr or a Cr alloy oriented in a (100) plane.

10. The magnetic recording medium of claim 1, further comprising
an amorphous seed layer disposed between the substrate and the nonmagnetic base layer, and containing an Ni—Nb alloy, an Ni—Ta alloy, an Ni—Zr alloy, an Ni—Mo alloy, or an Ni—V alloy.

11. The magnetic recording medium of claim 1, further comprising
a soft magnetic base layer disposed between the substrate and the nonmagnetic base layer.

12. A magnetic recording/reproducing apparatus, comprising:
the magnetic recording medium of claim 1; and
a magnetic head writing information into the magnetic recording medium or reproducing the information.

13. A method of manufacturing a magnetic recording medium, comprising:
preparing a substrate;
forming a nonmagnetic base layer on the substrate;
forming a perpendicular magnetic recording layer having a hard magnetic recording layer, a nonmagnetic intermediate layer, and a soft magnetic recording layer, on the nonmagnetic base layer;
dividing the perpendicular magnetic recording layer into mutually separated plural regions; and
forming a protective layer on the perpendicular magnetic recording layer,
wherein the hard magnetic recording layer has an easy magnetization axis directed to a stack direction of the hard magnetic recording layer, and
wherein the nonmagnetic intermediate layer includes one of C, ZnO, a carbide Si, Ti, Ta or W, and a nitride of Si, Ti, Ta or W.

14. The method of claim 13,
wherein the nonmagnetic intermediate layer contains carbon of not less than 50 atom % nor more than 100 atom %.

15. The method of claim 13,
wherein the nonmagnetic intermediate layer contains nitrogen of not less than 30 atom % nor more than 80 atom %.

16. The method of claim 13,
wherein the soft magnetic recording layer contains at least any one of Si, Ti, Al, Cr, and Mg of not less than 1 atom % nor more than 10 atom %.

17. The method of claim 13, further comprising
heating the substrate after the division and before the formation of the protective layer.

18. The method of claim 17,
wherein, in the heating of the substrate, a temperature of the substrate is not less than 400° C. nor more than 600° C.

19. The method of claim 13,
wherein, in the formation of the perpendicular magnetic recording layer, a temperature of the substrate is 200° C. or less.

20. The method of claim 13,
wherein the formation of the perpendicular magnetic recording layer comprises:
forming the hard magnetic recording layer on the nonmagnetic base layer, under a pressure of not less than 4 Pa nor more than 12 Pa;
forming the nonmagnetic intermediate layer on the hard magnetic recording layer, under a pressure of not less than 0.1 Pa nor more than 2 Pa; and
forming the soft magnetic recording layer on the nonmagnetic intermediate layer, under a pressure of not less than 0.1 Pa nor more than 2 Pa.
